(19) United States
(12) Patent Application Publication
(10) Pub. No.: US 2012/0010336 A1
(43) Pub. Date: Jan. 12, 2012

(54) FLAME RETARDED THERMOPLASTIC COMPOSITION, PROCESS FOR MAKING SAME AND ARTICLE CONTAINING SAME

(76) Inventors: Sergei V. Levchik, Croton-on-Hudson, NY (US); Ita Finberg, Beer-Sheva (IL); Yaov Bar-Yaakov, Lehavim (IL)

(21) Appl. No.: 13/144,783

(22) PCT Filed: Jan. 13, 2010
(86) PCT No.: PCT/US10/20905

§ 371 Date: Sep. 23, 2011

Related U.S. Application Data
(62) Division of application No. 61/205,958, filed on Jan. 26, 2009.

(51) Int. Cl. C08L 67/02; C09K 21/12; C08K 13/04; C08K 5/56; C08K 5/52

(52) U.S. Cl. 524/101; 524/127; 524/100; 252/609

(57) ABSTRACT

There is provided herein a flame retardant additive composition comprising:
a. at least one aromatic bisphosphate
b. at least one metal phosphonate; and,
c. at least one nitrogen-rich compound.
   There is also provided a thermoplastic polymer composition, containing thermoplastic polymer, e.g., thermoplastic polyester and the flame retardant additive composition; a method of making said flame retardant additive composition; and an article, e.g., an electronic component, containing the thermoplastic polymer composition.

### FIELD OF THE INVENTION

The present invention relates to flame-retarded thermoplastic compositions and more particularly to flame-retarded thermoplastic polyester compositions and articles containing the same, e.g., flame retarded electronic components.

### BACKGROUND OF THE INVENTION

Glass reinforced or non-reinforced thermoplastic polyesters, are used for the production of electronic parts such as connectors, frames, moving parts, transformers, micro motors, amongst others. In most of these applications, flame retardancy is needed and is usually provided by flame retardant systems based on a combination of brominated flame retardants with antimony trioxide as synergist. But this type of flame retardant system has a limitation once a high comparative tracking index (CTI) is needed and in such a case, halogen free flame retardant systems are preferred. Another reason for using halogen free systems is legislative limitations of use of halogen containing products in some applications and some geographic areas. However, halogen free systems are not easy to apply because of numerous negative impacts on polymer physical properties.

Non-halogenated flame retardants usually considered for engineering thermoplastics are phosphorus and/or nitrogen based. Unfortunately however, known flame retardant compositions heretofore have not provided sufficiently improved flame retardancy while still maintaining suitable levels of various physical properties such as impact resistance and heat deformation. Increasing the level of certain flame retardants beyond certain levels has shown to cause the flame retardant to exude out of the polymer matrix causing physical and aesthetic problems in injection molding operation and in the resultant injection molded parts.

In view of the foregoing, what is needed are flame retardants for use in thermoplastic compositions that have improved flame retardancy characteristics while avoid the problems described above.

### SUMMARY OF THE INVENTION

It has been unexpectedly discovered herein that a combination of two different sources of phosphorous (P) and a source of nitrogen (N) from nitrogen-containing compound provides significantly more efficient flame retardant efficiency in thermoplastic polymers, e.g., thermoplastic polyesters, preferably glass-reinforced polybutylene terephthalate or polyethylene terephthalate, with a minimal negative effect on resin melt flow properties, impact properties and heat distortion temperature (HDT).

The present invention is directed to a flame retardant additive composition comprising: a flame retardant additive composition comprising:
(a) at least one aromatic bisphosphate;
(b) at least one metal phosphonate; and,
(c) at least one nitrogen-rich compound.

Further, the present invention is also directed to an electronic component comprising a thermoplastic polymer, glass fiber, and a flame retardant additive composition, which composition comprises aromatic bisphosphate, aluminum methyl methyl phosphonate and melamine salt.

Still further, the present invention is directed to a method of making a flame retarded article comprising blending a thermoplastic polymer, optionally a solid filler, and the above-described flame retardant additive composition

### DETAILED DESCRIPTION OF THE INVENTION

The present invention is directed to flame retardant additive compositions that contain a unique and unexpected combination of phosphorous compounds and nitrogen-containing compound. Such flame retardant additive compositions can be used in thermoplastic polymers, which are reinforced or unreinforced to provide flame retardancy while maintaining suitable impact and HDT properties.

In one embodiment the aromatic bisphosphate is at least one aromatic bisphosphate. In another embodiment herein, the aromatic bisphosphate can be any aromatic bisphosphate described in European Patent No. EP0936243B1 the entire contents of which are hereby incorporated by reference, such as for example resorcinol bis(diphenyl)phosphate (Fyrolflex RDP from ICL-IP) and bisphenol-A bis(diphenylphosphate) (Fyrolflex BDP from ICL-IP). Still further, aromatic bisphosphate can comprise a blend of at least two of the herein described aromatic bisphosphates.

Preferably, the aromatic bisphosphate is at least one of aromatic bisphosphates or blends of aromatic phosphates having the general formula (I):

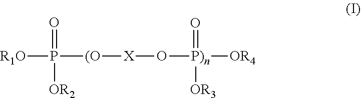

wherein R₁, R₂, R₃ and R₄ each independently is aryl or alkaryl, preferably aryl or alkyaryl containing up to about 12 carbon atoms, and n has an average value of from about 1.0 to about 2.0 and X is arylene, e.g. resorcinol, hydroquinone, 4,4′-biphenol, bisphenol A, bisphenol S, bisphenol F etc.

In one aspect of the present invention, phosphates within general formula (I), wherein n has an average value of about 1.0 to about 1.1 and X is hydroquinone, are in the form of free-flowing powders. Typically, but not limited thereto, “free-flowing powder” as applied to the phosphates of formula I have average particle sizes of about 10 μm to about 80 μm. These free-flowing powders, when compounded with thermoplastics, avoid various handling problems as well as impart improved physical properties such as, resin flow, UV stability, greater hydrolytic stability and higher heat distortion temperature (HDT) to the thermoplastic compositions.

In the general, the hydroquinone bis-phosphates of the present invention are prepared by reacting a diaryl halophosphate with hydroquinone in the presence of a catalyst. In a preferred embodiment of the invention, diphenylchlorophosphate (DPCP) is reacted with hydroquinone in the presence of MgCl₂ to produce hydroquinone bis-(diphenylphosphate). In accordance with the present invention, hydroquinone bis(diphenylphosphate) within general formula (I) prepared by this process will have an average n value of about 1.1 or less.

The metal phosphonate (b) used herein can be any metal phosphonate such as for example, aluminum methyl methylphosphonate (AMMP) which has the formula:

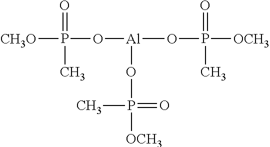

Metals which can be present in a metal phosphonate include alkaline earth or transitionary metals such as the non-limiting group consisting of Ca, Zn, Al, Fe, Ti and combinations thereof.

The nitrogen rich compound herein can be at least one selected from the group consisting of melamine salts, urea, urea derivatives, guanidine, and guanidine derivatives. The nitrogen-rich compound can be any of the nitrogen-containing compounds described in U.S. Pat. No. 6,503,969 the entire contents of which are incorporated herein by reference. In one embodiment a nitrogen-rich compound can comprise any nitrogen-containing compound that has at least 20 weight percent N, preferably at least 40 weight percent N.

In one non-limiting embodiment herein a nitrogen-rich compound can comprise a flame-retardant effective amount of a nitrogen-containing compound.

In one embodiment guanidine derivatives can comprise those selected from the group consisting of guanidine carbonate, guanidine cyanurate, guanidine phosphate, guanidine sulfate, guanidine pentaerythritol borate, guanidine neopentyl glycol borate, and combinations thereof.

In one embodiment the urea derivatives can comprise those selected from the group consisting of urea phosphate, urea cyanurate, and combinations thereof.

The nitrogen-rich compound can also comprise ammeline, ammelide; benzoguanamine itself or its adducts or salts, or the nitrogen-substituted derivatives or their adducts or salts; allatoin compound(s), glycolrils or salts of the same with acids such as carboxylic acids and combinations thereof.

In one embodiment herein the nitrogen rich compound can comprise two or more of any of the nitrogen-rich compounds described herein.

Preferably the melamine salts can be any of the melamine salts described in WO04/031286 A1, the entire contents of which are hereby incorporated by reference. Specifically, the melamine salts can be at least one compound selected from the group consisting of melamine phosphate, dimelamine phosphate, melamine pyrophosphate, melamine polyphosphate, melamine borate, melamine cyanurate, melamine oxalate, melamine sulfate, melam or melem phosphate, melam or melem polyphosphate, melamine ammonium phosphate, melamine ammonium pyrophosphate, melamine ammonium polyphosphate, condensation products of melamine, e.g., melem melam, melon and higher condensation products of melamine; and, mixtures thereof.

In preferred embodiment, the melamine salt is selected from the group consisting of melamine cyanurate, melamine phosphate, melamine pyrophosphate, and melamine polyphosphate.

In one embodiment herein the melamine salt can be a combination of any two or more of the herein described melamine salts.

The flame-retardant additive composition herein can further comprise an impact modifier, such as, for example, a terpolymer of ethylene, acrylic ester and glycidyl methacrylate. One non-limiting example of such a terpolymer is Lotader AX8900 available from Arkema.

The flame-retardant additive composition herein can further comprise a solid filler such as glass, preferably glass fiber.

The flame-retardant additive composition herein can further comprise a heat stabilizer and/or an antioxidant. An example of such a heat stabilizer/antioxidant is Irganox 1010 which is a hindered phenol available from Ciba.

In one embodiment herein the flame retardant additive composition comprises the aromatic bisphosphate (a) in an amount of from about 10 to about 90 weight percent; the phosphonate (b) is present in an amount of from about 10 to about 90 weight percent; and the nitrogen-rich compound (c) is present in an amount of from about 10 to about 90 weight percent, provided the total weight percent of the flame retardant additive composition equals 100 weight percent.

In a more specific embodiment, the flame retardant additive composition comprises the aromatic bisphosphate (a) in an amount of from about 20 to about 65 weight percent; the phosphonate (b) is present in an amount of from about 20 to about 65 weight percent; and the nitrogen-rich compound (c) is present in an amount of from about 20 to about 65 weight percent, provided the total weight percent of the flame retardant additive composition equals 100 weight percent.

In one embodiment of this invention the aromatic bisphosphate (a), the phosphonate (b) and the nitrogen rich compound (c) are introduced in the form of pellets. The pellets are produced by solid blending of the components and pelletization by any known technique known by those skilled in the art. Use of pellets in place of powders helps to avoid dusting during extrusion of PS foam.

In one another embodiment the aromatic bisphosphate (a), the phosphonate (b) and the nitrogen-rich compound (c) are thoroughly mixed together in the powdered form and then pelletized to produce pellets of the flame retardant concentrate.

In one another embodiment the aromatic bisphosphate (a), the phosphonate (b) and the nitrogen-rich compound (c) and optionally with antioxidants, stabilizers, nucleating agents and pigments mixed together in the powdered form and then pelletized to produce pellets.

In one embodiment there is provided herein a thermoplastic polymer composition which contains the flame retardant additive composition as described herein. Suitable thermoplastic polymers can include thermoplastic polyesters such as for example, at least one of polybutylene terephthalate and polyethylene terephthalate.

There is also provided herein a thermoplastic polymer composition which comprises at least one thermoplastic polymer and the flame retardant additive composition described herein. The flame retardant additive composition is present in the thermoplastic polymer composition in amounts of from about 2 to about 40 percent by weight, preferably from about 5 to about 35 percent by weight and most preferably from about 15 to about 35 percent by the total weight of such composition, with the remainder being thermoplastic polymer.

The above amounts of flame retardant additive in the thermoplastic polymer composition are flame retardant effective amounts of the flame retardant additive composition.

The thermoplastic polymer composition herein can have a flame retardancy classification of HB, V-2, V-1, V-0 and 5VA according to UL-94 protocol. In one embodiment the thermoplastic polymer composition can have a flame retardancy of at least V-1 or V-0 classification as is required in most electronic applications.

The thermoplastic polymer composition herein can have a notched IZOD impact rating of at least 35 J/m, as determined by ASTM D-256-81 method C.

The thermoplastic polymer composition herein can have a reverse notched IZOD impact rating of at least 140 μm as determined by ASTM D-256-81 method E.

The thermoplastic polymer composition herein can have a heat distortion temperature of at least 190 degrees Celsius, preferably at least 195 degrees Celsius.

In another embodiment herein there is provided a molded article comprising the thermoplastic composition, preferably where the molded article is made by injection molding.

The thermoplastic polymers used in the compositions of the present invention include but are not limited to poly(butylene terephthalate), poly(trimethylene terephthalate), poly(ethylene terephthalate), nylon 6, nylon 6.6, nylon 4.6, nylon 11, nylon 12, nylon 6.12, nylon 6T their blends with other polymers, for example with polycarbonate or polyphenylene ether and their copolymers; and combinations thereof.

The thermoplastic composition of the present invention are typically useful, for example, in the production of electronic components, such as for example, connectors, frames, moving parts, transformers and micromotors, and the like.

The thermoplastic composition of the present invention can also include other additives such as antioxidants, stabilizers, fillers anti-dripping agent such as fluorinated homo- or copolymers such as polytetrafluoroethylene or processing aid agents, nucleating agents, such as talc, pigments etc., as well as other flame retardants.

In a specific embodiment herein there is provided injection molded components, e.g., electronic components, comprising a thermoplastic polymer, glass fiber, and a flame retardant additive composition, which composition comprises hydroquinone bis-(diphenylphosphate), aluminum methyl methyl phosphonate and melamine salt.

In another embodiment there is provided a flame retarded article, e.g., an electronic component, preferably an injection molded electronic component, as described herein, made by the above-described method.

The following examples are used to illustrate the present invention.

### EXAMPLES

In order to prepare samples of flame retarded glass reinforced polybutylene terephthalate (PBT) that illustrate the invention, the following procedures have been used.

### 1. Materials.

The materials used in this study are presented in Table 1.

### 2. Compounding

Before compounding, the PBT pellets were dried in a circulating air oven ex Heraeus instruments at 120° C. for 4 hours.
PBT pellets and FR-6120 granules were weighted on Sartorius semi-analytical scales with consequent manual mixing in plastic bags. The mixtures were fed via polymer feeder of a K-SFS 24 gravimetric feeding system ex. K-Tron to the main feeding port of the extruder. Hydroquinone bis-(diphenylphosphate) and/or AMMP and or Melapur 200 were weighted on Sartorius semi analytical scales with consequent manual mixing in a plastic bag. The mixture was fed via powder feeder of the gravimetric feeding system ex. K-Tron to the main feeding port of the extruder.
Glass fibers were fed via lateral fiber feeder of gravimetric feeding system to the 5^{th} zone.
Compounding was performed in a twin-screw co-rotating extruder ZE25 with UD=32 ex Berstorff. The compounding conditions are presented in Table 2.
The extruded strands were pelletized in pelletizer 750/3 ex Accrapak Systems Ltd.
The obtained pellets were dried in a circulating air oven ex Heraeus instruments at 120° C. for 4 hours.

### 3. Injection Molding.

Test specimens were prepared by injection molding in Allrounderi 500-150 ex. Arburg. The injection molding conditions are presented in Table 3.

### 4. Conditioning

Specimens were conditioned at 23° C. for 168 hours before testing.
5. Test methods.
Tests used in this work are summarized in Table 4.
The percents used are weight percent based on the total weight of the composition.

In the first series of Examples 1 to 7, Example 1 is being used as a reference without any flame retardant and is classified Horizontal Burning (HB) according to the UL-94 standard. This classification is very weak in terms of flame retardancy.

In example 2, the addition of 25% of AMMP bringing as much as 6.5% P in the compounds did not improve the level of fire retardancy.

In example 3, addition of 20% of AMMP with 10% FR-6120 (melamine cyanurate) did not allow to improve the level of fire retardancy while the P and nitrogen (N) contents are 5.2 and 4.9% respectively.

In examples 4, 5 and 6, addition of 20% of AMMP with 10% Melapur 200 (melamine polyphosphate) or 22.5% AMMP and 10% FR-6120 or Melapur 200 started to improve the level of fire retardancy to get class V-1 or V-0 respectively.

But molded parts made by injection molding of these compounds (examples 2-6) have very poor impact properties not suitable for the production of electronic parts such as connectors. Moreover, as all these flame retardants (in examples 2-6) are not melt blendable, but are more filler-like, and thus, the melt flow properties of compositions containing these compounds and 30% of glass fiber are very poor and result in difficulty in the molding of thin wall parts.

In order to improve melt flow and impact, the use of hydroquinone bis-(diphenylphosphate) (a melt blendable phosphate ester with a melting range of 101-108° C.) as a replacement of non-blendable AMMP was tried as is shown in Example 7. Better melt flow and impact were obtained but the level of flame retardancy was lost as UL-94 class was reduced to HB.

A higher loading of hydroquinone bis-(diphenylphosphate) could not be tried as it reaches the limit of compatibility in PBT. With higher loading of hydroquinone bis-(diphenylphosphate) in PBT, the flame retardant starts to exude out of the polymer matrix and this causes a plate out on the surface of the mold during injection molding thus, deteriorating the surface appearance of molded parts.

Surprisingly, it has been found that the combination of two different sources of P, one coming from the metallic phosphonate and the other coming from the hydroquinone bis-(diphenylphosphate), with a source of nitrogen coming from the nitrogen-rich compound (melamine cyanurate or also possibly melamine polyphosphate) could provide a significantly more efficient flame retardant efficiency in the glass reinforced PBT with a minimum negative effect on impact properties and HDT as is illustrated by examples 8 and 9. Indeed, with significantly less P content (compare Example 8 and 9: 2.5 to 3.7% with Example 4 and 5: 6.5 and 5.9%) in the final composition while maintaining the nitrogen content (nitrogen atom content) at approximately (4.3-4.9%), the same level of fire retardancy is achieved.

It is also an object of this invention to select an impact modifier and get further improvement in impact properties while not losing the high level of fire retardancy using the same inventive flame retardant system described earlier, as can be seen in Examples 10 to 12. The conventional impact modifiers recommended for PBT applications are polycarbonate or methacrylate-butadiene-styrene terpolymer (MBS) (such as Makrolon 1143 or Clearstrength E-922). But these impact modifiers did not provide any improvement of impact properties, on the contrary, IZOD impact properties were reduced (Examples 10 and 11) while a terpolymer of ethylene, acrylic ester and glycidyl methacrylate (Lotader 8900) was found to increase significantly the IZOD impact while maintaining higher HDT and also the high flame retardancy (Example 12).

TABLE 1
Materials

| TRADE NAME | | |
|---|---|---|
| (PRODUCER) | GENERAL INFO | FUNCTION |
| PBT Celanex 2500 | Poly(butylene terephtalate) | plastic matrix |
| ex Ticona | | |
| Glass fibers for PBT | Glass fibers | Reinforcing |
| from Polyram | | agents |
| Hydroquinone bis- | bisphosphate | P-flame |
| (diphenylphosphate) | | retardant |
| ex ICL-IP | | |
| AMMP ex ICL-IP | Aluminum Methyl Methyl | P-Flame |
| | phosphonate | retardant |
| FR-6120 # 06052101 | Melamine cyanurate | Flame |
| granulary ex ICL-IP | | retardant |
| Melapur 200 | Melamine polyphosphate | Flame |
| Ex Ciba | | retardant |
| PC Makrolon 1143 | Polycarbonate | Impact |
| ex Bayer | (MFI 3 g/10 min) | improver |
| Clearstrength E920 | Methacrylate-butadiene- | Impact |
| ex Arkema | styrene (MBS) core-shell | modifier |
| | general purpose | |
| Lotader AX8900 | Random terpolymer of | Impact |
| ex Arkema | ethylene, acrylic ester and | modifier |
| | glycidyl methacrylate | |
| Irganox 1010 ex Ciba | Hindered phenol | Heat stabilizer/ |
| | | antioxidant |
| Acrawax C ex Lonza | N,N′ ethylene bisstearamide | Lubricant |

TABLE 2
Compounding in co-rotating twin-screw extruder ex Berstorff

| PARAMETER | UNITS | Set values | Set values |
|---|---|---|---|
| Screws | | Medium | Medium |
| | | shear A | shear A |
| Feeding zone | ° C. | no heating | no heating |
| temperature (T₁) | | | |
| T₂ | ° C. | 60 | 69-75 |
| T₃ | ° C. | 120 | 133-140 |
| _{T4} | ° C. | 250 | 243-254 |
| T₅ | ° C. | 260 | 256-268 |
| T₆ | ° C. | 260 | 259-286 |
| T₇ | ° C. | 260 | 251-274 |
| T₈ | ° C. | 265 | 251-286 |
| T₉ | ° C. | 270 | 247-278 |
| Temperature of melt | ° C. | | 251-279 |
| Screw speed | RPM | 350 | |
| Feeding rate | Kg/h | 15 | |

TABLE 3
Regime of injection molding in Arburg 320S Allrounder 500-150

| | | Set values for |
|---|---|---|
| | | specimens UL-94 & |
| PARAMETER | UNITS | mechanical properties |
| T₁ (Feeding zone) | ° C. | 230 |
| T₂ | ° C. | 255 |
| T₃ | ° C. | 265 |
| T₄ | ° C. | 265 |
| T₅ (nozzle) | ° C. | 270 |
| Mold temperature | ° C. | 90 |
| Injection pressure | bar | 100 |
| Holding pressure | bar | 850 |
| Back pressure | bar | 10 |
| Injection time | sec | 0.1 |
| Holding time | sec | 5.0 |
| Cooling time | sec | 5.0 |
| Mold closing force | kN | 500 |
| Filling volume (portion) | ccm | 19 |
| Injection speed | ccm/sec | 30 |
| Mold | | N° S 22963 |

TABLE 4
Test methods

| PROPERTY | METHOD | APPARATUS |
|---|---|---|
| Flammability vertical | UL-94 | Flammability hood as |
| burning test at 1.6 mm | | recommended by UL. |
| Izod notched impact | ASTM D-256-81 | Pendulum impact tester |
| energy | Method C | Type5102 ex. Zwick |
| Reversed notched test | ASTM D-256-81 | Pendulum impact tester |
| | Method E | Type5102 ex. Zwick |
| HDT(Deflection | Heat distortion test | HDT/VICAT-plus |
| temperature under | ASTM D648. Load | Davenport, Lloyd |
| flexural load of the | 1820 kPa; heating speed | instruments |
| test specimen) | 120° C./h. | |
| Tensile properties | ASTM D638-95 | Zwick 1435 material |
| | v = 5 mm/min | testing machine |

TABLE 5
Properties of flame retardant PBT: AMMP and/or
its combination with FR-6120 or Melapur 200 and/or
hydroquinone bis-(diphenylphosphate).

| | 1 = Ref. | 2. | 3 | 4 | 5 | 6 | 7 | 8 | 9 |
|---|---|---|---|---|---|---|---|---|---|
| Composition, wt % | | | | | | | | | |
| PBT | 69.6 | 44.6 | 39.6 | 39.6 | 37.1 | 37.1 | 34.6 | 44.6 | 39.6 |
| Glass fiber | 30 | 30 | 30 | 30 | 30 | 30 | 30 | 30 | 30 |
| Hydroquinone bis- | | | | | | | 20 | 10 | 10 |
| (diphenylphosphate) | | | | | | | | | |
| AMIMP | | 25 | 20 | 20 | 22.5 | 22.5 | | 5 | 10 |
| FR-6120 | | | 10 | | 10 | | 15 | 10 | 10 |
| Melapur 200 | | | | 10 | | 10 | | | |
| Ciba Specialty | | | | | | | | | |
| Chemicals | | | | | | | | | |
| Irganox 1010 | 0.2 | 0.2 | 0.2 | 0.2 | 0.2 | 0.2 | 0.2 | 0.2 | 0.2 |
| Acrawax C | 0.2 | 0.2 | 0.2 | 0.2 | 0.2 | 0.2 | 0.2 | 0.2 | 0.2 |
| Total FR loading, % | 0 | 25 | 30 | 30 | 32.5 | 32.5 | 35 | 25 | 30 |
| P content from | 0 | 0 | 0 | 0 | 0 | 0 | 2.1 | 1.1 | 1.1 |
| hydroquinone bis- | | | | | | | | | |
| (diphenylphosphate), | | | | | | | | | |
| % | | | | | | | | | |
| Total P content, % | 0 | 6.5 | 5.2 | 6.5 | 5.9 | 7.2 | 2.1 | 2.4 | 3.7 |
| calculated | | | | | | | | | |
| N content, % | 0 | | 4.9 | 4.3 | 4.9 | 4.3 | 7.4 | 4.9 | 4.9 |
| calculated | | | | | | | | | |
| Total P + N | 0 | 6.5 | 10.1 | 10.8 | 10.8 | 11.5 | 9.5 | 7.3 | 8.6 |
| content, % | | | | | | | | | |
| Properties | | | | | | | | | |
| Flame retardancy | | | | | | | | | |
| UL-94 (1.6 mm): | | | | | | | | | |
| Class | HB | HB | HB | V-1 | V-0 | V-0 | HB | V-1 | V-0 |
| Impact: | | | | | | | | | |
| notched IZOD, J/m | 52 | nd | nd | nd | 30 | 28 | 33 | 44 | 42 |
| Reversed notched | 363 | nd | nd | nd | 48 | 44 | 145 | 242 | 187 |
| IZOD, J/m | | | | | | | | | |
| HDT, ° C. | 208 | nd | nd | nd | 203 | 198 | 195 | 201 | 201 |

TABLE 6
Properties of impact modified FR PBT flame retarded
by the combination AMMP, FR-6120 and hydroquinone
bis-(diphenylphosphate).

| | 1 = Ref. | 9 = Ref. | 10 | 11 | 12 |
|---|---|---|---|---|---|
| Composition, wt % | | | | | |
| PBT | 69.6 | 39.6 | 34.6 | 34.6 | 34.6 |
| Glass fiber | 30 | 30 | 30 | 30 | 30 |
| Hydroquinone bis- | | 10 | 10 | 10 | 10 |
| (diphenylphosphate) | | | | | |
| AMMP | | 10 | 10 | 10 | 10 |
| FR-6120 | | 10 | 10 | 10 | 10 |
| PC Makrolon 1143 | | | 5 | | |
| Clearstrength E-922 | | | | 5 | |
| Lotader 8900 | | | | | 5 |
| Irganox 1010 | 0.2 | 0.2 | 0.2 | 0.2 | 0.2 |
| Acrawax C | 0.2 | 0.2 | 0.2 | 0.2 | 0.2 |
| Total FR loading, % | 0 | 30 | 30 | 30 | 30 |
| Properties | | | | | |
| Flame retardancy UL | | | | | |
| −94 (1.6 mm): | | | | | |
| Class | HB | V-0 | V-0 | V-0 | V-0 |
| Impact: | | | | | |
| notched IZOD, J/m | 52 | 42 | 40 | 35 | 56 |
| Reversed notched IZOD, J/m | 363 | 187 | 169 | 172 | 256 |
| HDT, ° C. | 208 | 201 | 196 | 195 | 197 |

1. A flame retardant additive composition comprising:
(a) at least one aromatic bisphosphate;
(b) at least one metal phosphonate; and,
(c) at least one nitrogen-rich compound.

2. The flame retardant additive composition of claim 1 wherein the aromatic bisphosphate is at least one aromatic bisphosphate selected from the groups consisting of the general formula (I): 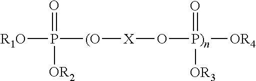
wherein R₁, R₂, R₃ and R₄ each independently is aryl or alkaryl and n has an average value of from about 1.0 to about 2.0 and X is arylene.

3. The flame retardant composition of claim 1, wherein arylene is selected from the group of resorcinol, hydroquinone, 4.4′-biphenol, bisphenol A, bisphenol S, bisphenol F

4. The flame retardant additive composition of claim 2 wherein the aromatic bisphosphate is hydroquinone bis-(diphenylphosphate).

5. The flame retardant additive composition of claim 1 wherein the metal phosphonate is aluminum methyl methylphosphonate.

6. The flame retardant additive composition of claim 1 wherein the nitrogen-rich compound is at least one compound selected from the group consisting of melamine salts, urea, urea derivatives, guanidine, and guanidine derivatives.

7. The flame retardant additive composition of claim 6 wherein the melamine salt is at least one compound selected from the group consisting of melamine cyanurate, melamine phosphate, melamine pyrophosphate, melamine polyphosphate, and any of the other melamine salts described herein.

8. The flame retardant additive composition of claim 1 wherein the aromatic bisphosphate (a) is present in an amount of from about 10 to about 90 weight percent; the phosphonate (b) is present in an amount of from about 10 to about 90 weight percent; and the nitrogen-reach compound (c) is present in an amount of from about 10 to about 90 weight percent.

9. A thermoplastic polymer composition comprising thermoplastic polymer and the flame retardant additive composition of claim 1.

10. The thermoplastic polymer composition of claim 9 wherein the thermoplastic polymer is a thermoplastic polyester.

11. The thermoplastic polymer composition of claim 10 wherein the thermoplastic polymer is at least one of poly(butylene terephthalate), poly(trimethylene terephthalate) and polyethylene terephthalate and blends and copolymers thereof.

12. The thermoplastic polymer composition of claim 9 further comprising at least one impact modifier.

13. The thermoplastic polymer composition of claim 12 wherein the impact modifier is a terpolymer of ethylene, acrylic ester and glycidyl methacrylate.

14. The thermoplastic polymer composition of claim 9 further comprising a filler.

15. The thermoplastic polymer composition of claim 14 wherein the filler is glass fiber.

16. The thermoplastic polymer composition of claim 9 further comprising a heat stabilizer and/or antioxidant.

17. A molded article comprising the thermoplastic polymer composition of claim 9.

18. The molded article of claim 17 wherein the molded article is made by injection molding.

19. An electronic component comprising the thermoplastic polymer composition of claim 9.

20. An electronic component comprising a thermoplastic polymer, glass fiber, and a flame retardant additive composition, which composition comprises hydroquinone bis-(diphenylphosphate), aluminum methyl methyl phosphonate and melamine salt.

21. A method of making a flame retarded article comprising blending a thermoplastic polymer, optionally a solid filler, and a flame retardant additive composition comprising
a. at least one aromatic bisphosphate;
b. at least one metal phosphonate; and,
c. at least one nitrogen-rich compound.

22. A flame retarded article made by the method of claim 21.

23. The flame retarded article of claim 22 wherein the article is an injection molded electronic component.
